(19) United States
(12) Patent Application Publication
(10) Pub. No.: US 2024/0297603 A1
(43) Pub. Date: Sep. 5, 2024

(54) DEVICE FOR DETECTING THE DIRECTION OF ROTATION OF A ROTOR, ASSOCIATED CONTROL AND DRIVE SYSTEM, AND ASSOCIATED METHOD

(71) Applicant: SKF Magnetic Mechatronics, Saint-Marcel (FR)

(72) Inventors: Sylvain PALMERI, Angerville la campagne (FR); Lakdar SADI-HADDAD, Nogent sur Marne (FR)

(21) Appl. No.: 18/585,346

(22) Filed: Feb. 23, 2024

(30) Foreign Application Priority Data
Mar. 2, 2023 (FR) 2301930

(51) Int. Cl. H02P 27/04; H02K 7/09; H02P 6/18

(52) U.S. Cl. CPC H02P 27/045; H02P 6/18; H02K 7/09

(57) ABSTRACT

A device for detecting a change in the direction of rotation of a rotor for a magnetic bearing. The device includes a determining means (102) and a comparing means (103). The determining means (102) determines a spacing between the axis of rotation of the rotor and the centre of gravity of the rotor. The comparing means (103) compares the spacing between the axis of rotation of the rotor and the centre of gravity of the rotor with a predefined threshold (Se) when the absolute value of the speed of rotation of the rotor is greater than a predefined imbalance detection speed threshold (S_{B}). The comparing means (103) also detects the change in the direction of rotation of the rotor from the result of the comparison.

### CROSS-REFERENCE TO RELATED APPLICATION

This application claims priority to French Application No. 2301930, filed Mar. 2, 2023, the entirety of which is hereby incorporated by reference.

### FIELD

The present disclosure relates to the control of magnetic bearings.

The present disclosure more particularly relates to a device for detecting the direction of rotation of a rotor of a magnetic bearing, to a system for controlling a magnetic bearing comprising such a device, to a drive system having such a system and a magnetic bearing, and to a method for detecting a change in the direction of rotation of the rotor.

### BACKGROUND

Conventionally, magnetic bearings are implemented in systems having a rotor operating at a high rotational speed.

A magnetic bearing supports the rotor by magnetic levitation in a stator of the system.

The magnetic bearings are controlled by a control system generally comprising a synchronous filter implementing algorithms for controlling the magnetic bearing.

The synchronous filter comprises a modulation module which changes the reference system from a stator reference system to a rotor reference system, an algorithm for controlling the magnetic bearing which performs operations in the rotor reference system in order to simplify said operations, and a demodulation module which changes the reference system from the rotor reference system to the stator reference system.

The operations for changing the reference system implement trigonometric functions that depend on the direction of rotation of the rotor.

When the control system is started up, the direction of rotation of the rotor is defined and input in the modulation and demodulation modules manually by an operator.

If the direction of rotation that was input is not representative of the direction of rotation of the rotor, the modulation module supplies a zero value after filtering.

The operator can make an error regarding the direction of rotation that is liable to adversely affect the system in which the bearing is implemented.

Moreover, when it is necessary to modify the direction of rotation, an operator must intervene to manually change the direction of rotation of the rotor.

It is therefore proposed to overcome all or some of these drawbacks.

### SUMMARY

In light of the above, the present disclosure proposes a method for detecting a change in the direction of rotation of a rotor of a magnetic bearing, comprising:
determining the speed of rotation of the rotor, determining a spacing between the axis of rotation of the rotor and the centre of gravity of the rotor,
comparing the spacing between the axis of rotation of the rotor and the centre of gravity of the rotor with a predefined threshold when the absolute value of the speed of rotation of the rotor is greater than a predefined imbalance detection speed threshold, and
detecting the change in the direction of rotation of the rotor from the result of the comparison.

The change in the direction of rotation of the rotor is detected from the speed of rotation of the rotor and from the spacing between the axis of rotation of the rotor and the centre of gravity of the rotor representative of the imbalance of the rotor in order to adapt the algorithms for controlling the magnetic bearing autonomously and automatically without manual intervention by an operator.

The imbalance is generated by an uneven distribution of the mass of the rotor with respect to its axis of rotation.

Preferably, the method comprises detecting a first reversal of the direction of rotation of the rotor in a second direction of rotation that is counter to the first direction of rotation, when the absolute value of the speed of rotation of the rotor is greater than the imbalance detection speed threshold and when the spacing between the axis of rotation of the rotor and the centre of gravity of the rotor is less than the predefined threshold.

Advantageously, the method comprises detecting a second reversal of the direction of rotation of the rotor following the first reversal when the absolute value of the speed of rotation of the rotor is greater than the imbalance detection speed threshold and when the spacing between the axis of rotation of the rotor and the centre of gravity of the rotor is less than the predefined threshold.

What is also proposed is a device for detecting a change in the direction of rotation of a rotor for a magnetic bearing, comprising:
determining means configured to determine a spacing between the axis of rotation of the rotor and the centre of gravity of the rotor,
comparing means configured to:
   compare the spacing between the axis of rotation of the rotor and the centre of gravity of the rotor with a predefined threshold when the absolute value of the speed of rotation of the rotor is greater than a predefined imbalance detection speed threshold, and
   detect the change in the direction of rotation of the rotor from the result of the comparison.

Advantageously, the comparing means are configured to detect a first reversal of the direction of rotation of the rotor in a second direction of rotation that is counter to the first direction of rotation, when the absolute value of the speed of rotation of the rotor is greater than the imbalance detection speed threshold and when the spacing between the axis of rotation of the rotor and the centre of gravity of the rotor is less than the predefined threshold.

Preferably, the comparing means are also configured to detect a second reversal of the direction of rotation of the rotor following the first reversal when the absolute value of the speed of rotation of the rotor is greater than the imbalance detection speed threshold and when the spacing between the axis of rotation of the rotor and the centre of gravity of the rotor is less than the predefined threshold.

What is also proposed is a control system for a magnetic bearing comprising a device as defined above, and a synchronous filter including at least one algorithm for managing the magnetic bearing, the algorithm comprising a variable gain managed by said device depending on the direction of rotation of the rotor.

The synchronous filter preferably comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

Advantageously, the synchronous filter also comprises a control module connected on the one hand to the modulation module and on the other hand to the demodulation module, the control module implementing an algorithm for correcting the imbalance of the rotor.

What is also proposed is a drive system comprising a magnetic bearing having a rotor and a stator having coils distributed evenly in the stator forming at least one servocontrol spindle, a power converter supplying power to the servocontrol spindle, and a control system as defined above managing the power converter.

### BRIEF DESCRIPTION OF THE DRAWINGS

Further aims, features and advantages of the present disclosure will become apparent from reading the following description, which is given purely by way of nonlimiting example and with reference to the appended drawings, in which:

FIG. 1 illustrates an example of a drive system according to the present disclosure;

FIG. 2 schematically illustrates an exemplary embodiment of a control system for a magnetic bearing according to the present disclosure;

FIG. 3 schematically illustrates one embodiment of a modulation module according to the present disclosure;

FIG. 4 schematically illustrates an exemplary embodiment of a control module according to the present disclosure;

FIG. 5 schematically illustrates an exemplary embodiment of the detection device according to the present disclosure; and

FIG. 6 illustrates an implementation example for the exemplary embodiment of the detection device according to the present disclosure.

### DETAILED DESCRIPTION

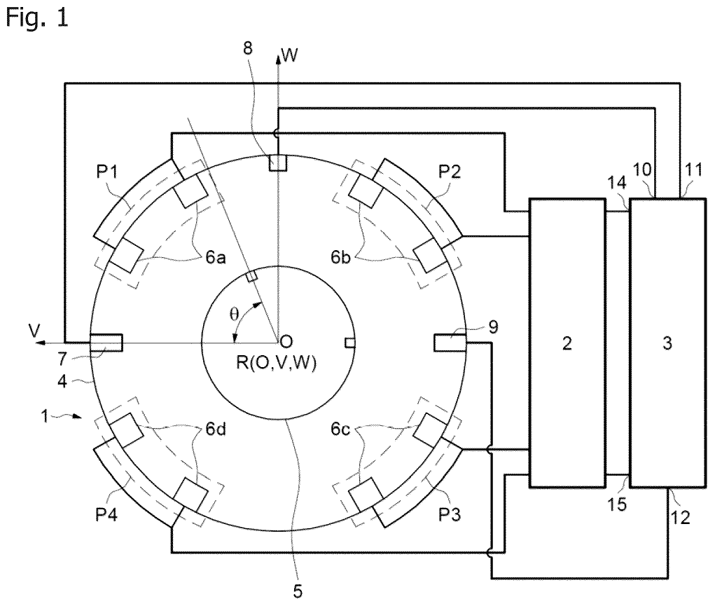

Reference is made to FIG. 1, which illustrates a drive system comprising a magnetic bearing 1, a power converter 2 and a control system 3.

As is known per se, the magnetic bearing 1 comprises a stator 4 and a rotor 5 positioned in the stator 4, and a direct orthogonal reference system R(O, V, W) having two aces V, W and an origin O centred on the axis of rotation of the rotor 5.

The stator 4 comprises coils 6 distributed evenly in the circumferential direction of the inner side of the stator 4, two diametrically opposite coils being connected to one another so as to be supplied with power at the same time by the power converter 2.

Two diametrically opposite stator coils define a servocontrol spindle of the magnetic bearing and make it possible to manage this spindle.

The stator 4 comprises for example four coils 6a, 6b, 6c, 6d forming four pairs of poles P1, P2, P3, P4 connected to the power converter 2.

The stator 4 also comprises two position sensors 7, 8 for the rotor 5 that measure the position of the rotor 5.

A first position sensor 7 is disposed on a first axis V of the reference system R(O, V, W) and a second position sensor 8 is disposed on the second axis W of the reference system R(O, V, W).

The stator 4 also comprises a speed sensor 9 that measures the speed of rotation of the rotor 5.

The measurements generated by the position sensors 7, 8 are sent to the inputs 10, 11 of the control system 3 and the measurements generated by the speed sensor are sent to a third input 12 of the control system 3.

The control system 3 also comprises two outputs 14, 15 connected to the power converter 2.

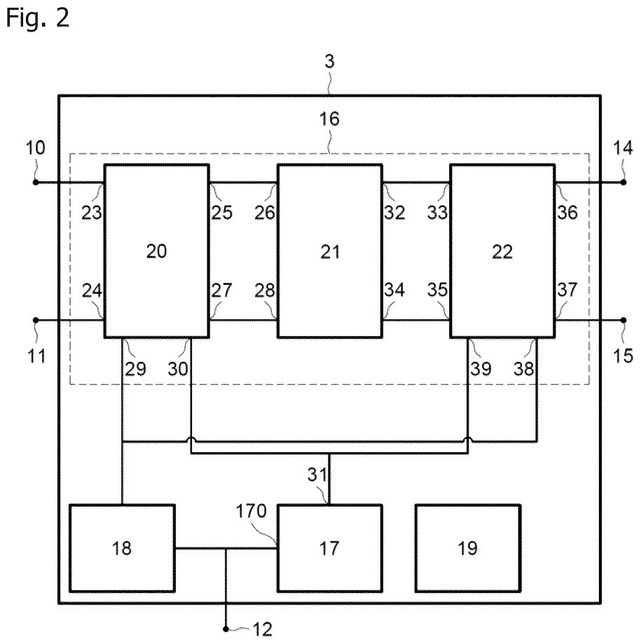

FIG. 2 schematically illustrates an exemplary embodiment of the control system 3.

The control system 3 comprises a synchronous filter 16, a device 17 for detecting a change in the direction of rotation of the rotor 5, and means 18 for determining the angular position of the rotor 5 from the measurements supplied by the speed sensor 9.

The control system 3 also comprises a processing unit 19 implementing the synchronous filter 16, the detection device 17, and the means 18 for determining the angular position connected to the third input 12.

The angular position determining means 18 determine, in a known manner, the angular position of the rotor 5 from the data generated by the speed sensor 9 by estimating the duration needed for the rotor 5 to perform one revolution over a first period of rotation of the rotor 5, then carries out a linear interpolation over the estimated duration to estimate the position of the rotor 5 over a second period following the first period of rotation.

The synchronous filter 16 comprises a modulation module 20, a control module 21 and a demodulation module 22.

The modulation module 20 comprises a first input 23 connected to a first input 10 of the control system 3, a second input 24 connected to the second input 11 of the control system 3, a first output 25 connected to a first input 26 of the control module 21, and a second output 27 connected to a second input 28 of the control module 2.

The modulation module 20 also comprises a third input 29 connected to the angular position determining means 18, and a control input 30 connected to an output 31 of the detection device 17.

The detection device 17 comprises an input 170 connected to the third input 12 of the control system 3.

The control module 21 comprises a first output 32 connected to a first input 33 of the demodulation module 22, and a second output 34 connected to a second input 35 of the demodulation module 22.

The demodulation module 22 also comprises a first output 36 connected to the first output 14 of the control module 3, and a second output 37 connected to a second output 15 of the control module 3.

The demodulation module 22 also comprises a third input 38 connected to the angular position determining means 18, and a control input 39 connected to an output 31 of the detection device 17.

As is known, the modulation module 20 filters the sinusoidal signals supplied by the position sensors 7, 8 such that the first output 25 supplies a first continuous value indicative of the amplitude of the sinusoidal signal supplied by the first position sensor 7, and such that the second output 27 supplies a second continuous value indicative of the amplitude of the sinusoidal signal supplied by the second position sensor 8.

The modulation module 20 implements a low-frequency filtering algorithm allowing frequencies to pass that are equal to the frequency of rotation of the rotor 5 to within an activation threshold S_{A} so as to also make it possible to change the basis of the reference system R(O, V, W) to a direct orthogonal reference system R1 of the rotor 5 of which the origin is a point on the axis of rotation of the rotor 5.

The activation threshold S_{A} is for example equal to 80 Hz.

The first and second continuous values supplied are representative of the spacing between the axis of rotation of the rotor 5 and the centre of gravity of the rotor 5, and make it possible to quantify the imbalance of the rotor 5.

The control module 21 implements an algorithm for correcting the imbalance determined by the modulation module 20 and the demodulation module 22 changes the reference system R1 linked to the rotor 5 to the reference system R linked to the stator 4.

As the modulation module 20 and demodulation module 22 have similar structures, only one exemplary embodiment of the modulation module 20 and one exemplary embodiment of the processing module 21 are presented below.

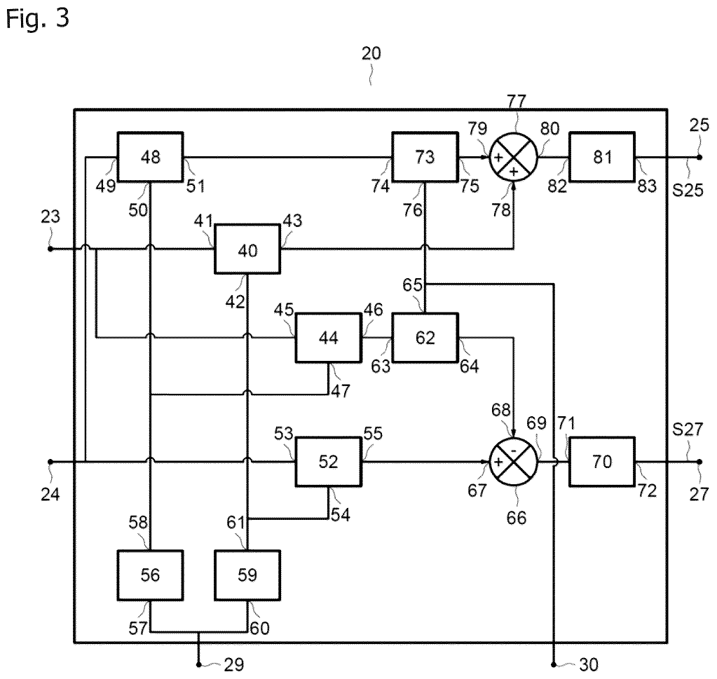

FIG. 3 schematically illustrates an exemplary embodiment of the modulation module 20.

The modulation module 20 comprises four multipliers 40, 44, 52, 48 each comprising a first input 41, 45, 49, 53, a second input 42, 47, 50, 52, and an output 43, 46, 51, 55.

The modulation module 20 comprises a sine operator 56 comprising an input 57 connected to the third input 29 of the modulation module 20 and an output 58 connected to the second inputs 47, 50 of a second and a third multiplier 44, 48.

The modulation module 20 also comprises a cosine operator 59 comprising an input 60 connected to the third input 29 of the modulation module 20 and an output 61 connected to the second inputs 42, 54 of a first and a fourth multiplier 44, 52.

The first inputs 41, 54 of the first and the second multiplier 40, 44 are connected to the first input 23 of the modulation module 20, and the first inputs 49, 53 of the third and the fourth multipliers 48, 52 are connected to the second input 24 of the modulation module 20.

The modulation module 20 also comprises a first variable gain 62 comprising an input 63 connected to the output 46 of the second multiplier 44, an output 64, and a management input 65 connected to the control input 30 of the modulation module 20.

The modulation module 20 comprises a first adder 66 comprising an addition input 67 connected to the output 55 of the fourth adder 52, a subtraction input 68 connected to the output 64 of the first gain 62, and an output 69 connected to an input 71 of a saturator 70 of the module 20.

The saturator 70 also comprises an output 72 connected to the second output 27 of the module 20.

The modulation module 20 also comprises a second variable gain 73 comprising an input 74 connected to the output 51 of the third multiplier 48, an output 75, and a management input 76 connected to the control input 30 of the modulation module 20.

The module comprises a second adder 77 comprising a first addition input 78 connected to the output 43 of the first adder 40, a second addition input 79 connected to the output 75 of the second gain 73, and an output 80 connected to an input 82 of a second saturator 81 of the module 20.

The second saturator 81 also comprises an output 83 connected to the first output 25 of the module 20.

The saturators 70, 81 make it possible to avoid the reversals of variables associated with the fixed-point coding of the control system 3.

The first and second gains 62, 73 are managed such that they multiply the value received at their input 63, 74 by a multiplying coefficient which takes the numerical value 1 or −1 depending on the direction of rotation of the rotor 5.

If the direction of rotation of the rotor 5 is oriented from the axis V to the axis W in the reference system R (reverse direction), the multiplying coefficient is for example equal to 1, and if the direction of rotation of the rotor 5 is oriented from the axis W to the axis V in the reference system R (forward direction), the multiplying coefficient is equal to −1.

The value of the multiplying coefficient is determined by the detection device 17, as described below.

It is assumed that the first position sensor 7 supplies a sinusoidal signal Vcos and that the second position sensor 8 supplies a sinusoidal signal Vsin such that:

$$V cos = A cos ( θ ) \qquad ( 1 )$$

$$V sin = Asin ( θ ) \qquad ( 2 )$$

where A is the amplitude of the signals and θ is the angular position of the rotor 5.

When the rotor 5 revolves in the forward direction, the coefficient of the gains 62, 73 is equal to 1. A signal S25 at the first output 25 and a signal S27 at the second output 27 are equal to:

$$S 25 = A sin ( θ ) sin ( θ ) + A cos ( θ ) cos ( θ ) = A \qquad ( 3 )$$

$$S 27 = A sin ( θ ) cos ( θ ) - A cos ( θ ) sin ( θ ) = 0 \qquad ( 4 )$$

When the rotor 5 revolves in the reverse direction, the coefficient of the gains 62, 73 is equal to −1. The signal S25 at the first output 25 and the signal S27 at the second output 27 are equal to:

$$S 25 = - A cos ( θ ) sin ( θ ) + Asin ( θ ) cos ( θ ) = 0 \qquad ( 3 )$$

$$S 27 = A cos ( θ ) cos ( θ ) + A sin ( θ ) sin ( θ ) = A \qquad ( 4 )$$

The first and second non-zero continuous values supplied at the outputs 25, 27 are representative of the spacing between the axis of rotation of the rotor 5 and the centre of gravity of the rotor 5, and make it possible to quantify the imbalance of the rotor 5.

The module 20 makes it possible to filter the signals generated by the position sensors independently of the direction of rotation of the rotor 5 by selecting the gain of the gains 73, 62 to be equal to the multiplying coefficient, the selection being performed by the detection device 17.

The gain of the variable gains 73, 62 is representative of the direction of rotation of the rotor 5.

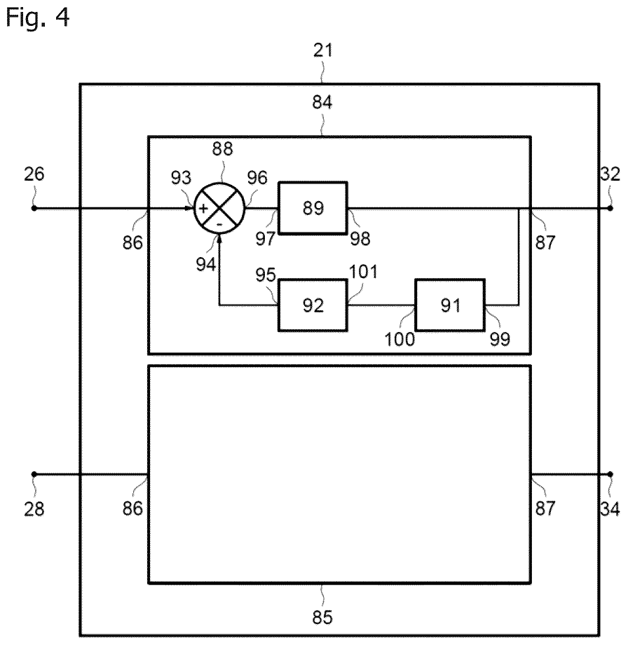

FIG. 4 schematically illustrates an exemplary embodiment of the control module 21 that makes it possible to compensate the imbalance of the rotor 5 determined by the modulation module 20.

The modulation module 20 has two identical regulating loops 84, 85 each having an input 86 and an output 87.

The input 86 and the output 87 of a first regulating loop 84 are connected to the first input 26 and to the first output 32, respectively, of the control module 21.

The input 86 and the output 87 of the second regulating loop 85 are connected to the second input 28 and to the second output 34, respectively, of the control module 21.

Since the regulating loops 84, 85 are identical, only the first loop 84 is described in detail.

The first loop 84 comprises an adder 88, an integrator 89, a gain 91 and a saturator 92.

The adder 88 comprises an addition input 93 connected to the input 86, a subtraction input 94 connected to an output 95 of the saturator 92, and an output 96 connected to an input 97 of the integrator 89.

An output 98 of the integrator is connected to the output 87 and to an input 99 of the gain.

An output 100 of the gain 91 is connected to an input 101 of the saturator 92.

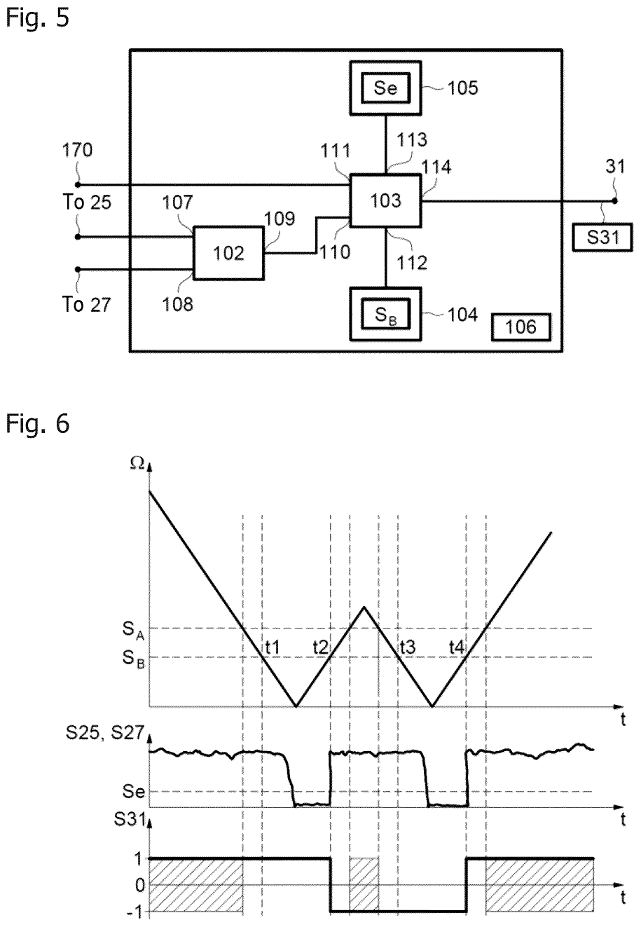

FIG. 5 discloses an exemplary embodiment of the detection device 17.

The device 17 comprises determining means 102, comparing means 103, a first memory 104, and a second memory 105.

Each of the first and second memories 104, 105 may be disposed in the device 17 as shown or disposed outside the device 17.

The device 17 also comprises a second processing unit 106 implementing the determining means 102, the comparing means 103, and the first and second memories 104, 105.

The determining means 102 have a first input 107 connected to the first output 25 of the modulation module 20, a second input 108 connected to the second output 27 of the modulation module 20, and an output 109 connected to a first input 110 of the comparing means 103.

The comparing means 103 also have a second input 111 connected to the input 170 of the device 17, a third input 112 connected to the first memory 104, and a fourth input 113 connected to the second memory 105.

The comparing means 103 have an output 114 connected to the output 31 of the detection device 17.

When the direction of rotation of the rotor 5 is reversed and when the multiplying coefficient of the gains 67, 73 is not reversed, the outputs 25, 27 of the modulation module 20 each supply a zero value which can be interpreted as a rotor 5 not exhibiting an imbalance.

It is known that a rotor always exhibits an imbalance generated by the manufacturing tolerances of the rotor 5, and consequently the signals supplied by the modulation module 20 at the outputs 25, 27 cannot simultaneously be zero.

In this embodiment, the determining means 102 determine a spacing between the axis of rotation of the rotor 5 and the centre of gravity of the rotor 5 by reading each of the outputs 25, 27 of the modulation module 20, and supply the value of the spacing at the first input 110 of the comparing means 103.

The first memory 104 contains an imbalance detection speed threshold S_{B} determined, for example, by tests on the rotor 5 at a test bench.

The imbalance of the rotor 5 can be detected by the determining means 102 when the speed of the rotor 5 is at least equal to the imbalance detection speed threshold S_{B}.

The second memory 105 contains a predefined threshold Se.

If the value of the spacing determined by the determining means 102 is greater than the threshold Se, the imbalance of the rotor 5 is considered to be non-zero.

In the reverse case, the imbalance of the rotor 5 is considered to be zero.

The threshold Se is determined from the resolution of the modulation module 20 and the speed sensor 9.

The comparing means 103 can compare the spacing between the axis of rotation of the rotor and the centre of gravity of the rotor with the predetermined threshold when the absolute value of the speed of rotation of the rotor is greater than the imbalance detection speed threshold S_{B}, and detect the change in the direction of rotation of the rotor 5 from the result of the comparison.

It is assumed below that the speed measured by the speed sensor 9 is the absolute value of the speed of rotation of the rotor 5 such that the measured speed is positive or zero.

An implementation example for the second exemplary embodiment of the detection device 17 illustrated in FIG. 6 is now described in detail.

FIG. 6 illustrates an example of the change over time of the speed of rotation χ of the rotor 5, signals S25, S27 at the outputs 25, 27 of the modulation module 20, and the signal S31 supplied at the output 31 of the detection device 17.

It is assumed that, before an instant t1, the rotor 5 revolves in the reverse direction at a decreasing speed of rotation greater than the imbalance detection threshold S_{B}, and that the signals S25, S27 are greater than the threshold Se.

As the speed of rotation Ω of the rotor 5 is greater than the imbalance detection threshold S_{B} and the signals S25, S27 are greater than the threshold Se, the comparing means 103 supply at the output 114 a signal representative of the value of the multiplying coefficient of the gains 62, 73 that is equal to “1”.

As long as the speed of rotation Ω of the rotor 5 is greater than the activation threshold S_{A}, the filtering algorithm of the modulation module 20 is active (hatched areas).

Between the instant t1 and an instant t2, the absolute value of the speed of rotation Ω of the rotor 5 decreases down to zero and then increases to reach the imbalance detection threshold S_{B} at the instant t2.

The signal S31 remains in the previous state “1”.

At the instant t2, the absolute value of the speed of rotation Ω of the rotor 5 is greater than the detection speed threshold S_{B} and the signals S25, S27 are less than the threshold Se.

The comparing means 103 determine a reversal of the direction of rotation of the rotor 5 from the reverse direction to the forward direction, and supply a signal representative of the value of the multiplying coefficient of the gains 62, 73 that is equal to “−1” such that the signal S31 is equal to “−1”.

The multiplying coefficient of the gains 62, 73 is equal to “−1”.

Between the instant t2 and an instant t3, the absolute value of the speed of rotation Ω of the rotor 5 is greater than the detection speed threshold S_{B} and the signals S25, S27 are greater than the threshold Se.

The signal S31 remains in the previous state “−1”.

Between the instant t3 and an instant t4, the absolute value of the speed of rotation Ω of the rotor 5 increases and remains less than the detection speed threshold S_{B}. The signal S31 remains in the previous state “−1”.

At the instant t4, the absolute value of the speed of rotation Ω of the rotor 5 is equal to the detection speed threshold S_{B} and the signals S25, S27 are less than the threshold Se.

The comparing means 103 determine a reversal of the direction of rotation of the rotor 5 from the forward direction to the reverse direction, and supply the signal representative of the value of the multiplying coefficient of the gains 62, 73 equal to “1” such that the signal S31 is equal to “1”.

The multiplying coefficient of the gains 62, 73 is equal to “1”.

After the instant t4, as the absolute value of the speed of rotation Ω of the rotor 5 is greater than the detection speed threshold S_{B} and the signals S25, S27 are greater than the threshold Se, the signal S31 remains in the previous state “1”.

The detection device 17 makes it possible to detect a change in the direction of rotation of the rotor 5 from the speed of rotation of the rotor 5 and from the spacing between the axis of rotation of the rotor and the centre of gravity of the rotor representative of the imbalance of the rotor 5 in order to adapt the algorithms for controlling the magnetic bearing 1 which are implemented by the synchronous filter autonomously and automatically without manual intervention by an operator.

As a variant, the detection of the change in the direction of rotation of the rotor by the detection device 17 makes it possible to activate/deactivate the synchronous filter 16 depending on the direction of rotation of the rotor.

What is claimed is:

1. A method for detecting a change in the direction of rotation of a rotor of a magnetic bearing, comprising:
determining the speed of rotation of the rotor,
determining a spacing between the axis of rotation of the rotor and the centre of gravity of the rotor,
comparing the spacing between the axis of rotation of the rotor and the centre of gravity of the rotor with a predefined threshold when the absolute value of the speed of rotation of the rotor is greater than a predefined imbalance detection speed threshold, and
detecting the change in the direction of rotation of the rotor from the result of the comparison.

2. The method according to claim 1, comprising detecting a first reversal of the direction of rotation of the rotor in a second direction of rotation that is counter to the first direction of rotation, when the absolute value of the speed of rotation of the rotor is greater than the imbalance detection speed threshold and when the spacing between the axis of rotation of the rotor and the centre of gravity of the rotor is less than the predefined threshold.

3. The method according to claim 2, comprising detecting a second reversal of the direction of rotation of the rotor following the first reversal, when the absolute value of the speed of rotation of the rotor is greater than the imbalance detection speed threshold and when the spacing between the axis of rotation of the rotor and the centre of gravity of the rotor is less than the predefined threshold.

4. A device for detecting a change in the direction of rotation of a rotor for a magnetic bearing, comprising:
determining means configured to determine a spacing between the axis of rotation of the rotor and the centre of gravity of the rotor,
comparing means configured to:
compare the spacing between the axis of rotation of the rotor and the centre of gravity of the rotor with a predefined threshold when the absolute value of the speed of rotation of the rotor is greater than a predefined imbalance detection speed threshold, and
detect the change in the direction of rotation of the rotor from the result of the comparison.

5. The device according to claim 4, wherein the comparing means are configured to detect a first reversal of the direction of rotation of the rotor in a second direction of rotation that is counter to the first direction of rotation, when the absolute value of the speed of rotation of the rotor is greater than the imbalance detection speed threshold and when the spacing between the axis of rotation of the rotor and the centre of gravity of the rotor is less than the predefined threshold.

6. The device according to claim 5, wherein the comparing means are also configured to detect a second reversal of the direction of rotation of the rotor following the first reversal, when the absolute value of the speed of rotation of the rotor is greater than the imbalance detection speed threshold and when the spacing between the axis of rotation of the rotor and the centre of gravity of the rotor is less than the predefined threshold.

7. A control system for a magnetic bearing comprising the device according to claim 4, and a synchronous filter including at least one algorithm for managing the magnetic bearing, the algorithm comprising a variable gain managed by said device depending on the direction of rotation of the rotor.

8. The control system according to claim 7, wherein the synchronous filter comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

9. The control system according to claim 8, wherein the synchronous filter also comprises a control module connected on the one hand to the modulation module and on the other hand to the demodulation module, the control module implementing an algorithm for correcting the imbalance of the rotor.

10. A drive system comprising a magnetic bearing having a rotor and a stator having coils distributed evenly in the stator forming at least one servocontrol spindle, a power converter supplying power to the servocontrol spindle, and the control system according to claim 7 managing the power converter.

11. A control system for a magnetic bearing comprising the device according to claim 6, and a synchronous filter including at least one algorithm for managing the magnetic bearing, the algorithm comprising a variable gain managed by said device depending on the direction of rotation of the rotor.

12. The control system according to claim 11, wherein the synchronous filter comprises a modulation module and a demodulation module, the modulation module comprising a first algorithm comprising at least one variable gain managed by said device depending on the direction of rotation of the rotor, and the demodulation module comprising a second algorithm comprising at least one variable gain managed by said device depending on the direction of rotation of the rotor.

13. The control system according to claim 12, wherein the synchronous filter also comprises a control module connected on the one hand to the modulation module and on the other hand to the demodulation module, the control module implementing an algorithm for correcting the imbalance of the rotor.

14. A drive system comprising a magnetic bearing having a rotor and a stator having coils distributed evenly in the stator forming at least one servocontrol spindle, a power converter supplying power to the servocontrol spindle, and the control system according to claim 13 managing the power converter.
